(19) United States
(12) Patent Application Publication
(10) Pub. No.: US 2026/0194700 A1
(43) Pub. Date: Jul. 9, 2026

(54) LAMINATE, DISPLAY DEVICE, AND WOUND ROLL

(71) Applicant: FUJIFILM Corporation, Tokyo (JP)

(72) Inventors: Hideki KANEIWA, Minamiashigara-shi (JP); Yasukazu KUWAYAMA, Minamiashigara-shi (JP)

(73) Assignee: FUJIFILM Corporation, Tokyo (JP)

(21) Appl. No.: 19/558,501

(22) Filed: Mar. 6, 2026

Related U.S. Application Data
(63) Continuation of application No. PCT/JP2024/033949, filed on Sep. 24, 2024.

(30) Foreign Application Priority Data
Sep. 29, 2023 (JP) 2023-169162

(51) Int. Cl. G02B 5/30

(52) U.S. Cl. CPC G02B 5/3016

(57) ABSTRACT

A laminate is provided from which a larger number of members suitable for head-mounted displays can be cut while suppressing ghosting. The laminate includes a first optically anisotropic film and a second optically anisotropic film. An average orientation of directions in which optical anisotropy of the first film is largest defines a first average orientation, and an average orientation of directions in which optical anisotropy of the second film is largest defines a second average orientation. A maximum deviation from the first average orientation is 0.5°-5.0°. An angle α between the first and second average orientations satisfies 10°<α<80°. An angle β between anisotropy directions of the films satisfies 0°<|β−α<1°.

### CROSS-REFERENCE TO RELATED APPLICATIONS

This application is a Continuation of PCT International Application No. PCT/JP2024/033949 filed on Sep. 24, 2024, which claims priority under 35 U.S.C. § 119(a) to Japanese Patent Application No. 2023-169162 filed on Sep. 29, 2023. The above applications are hereby expressly incorporated by reference, in their entirety, into the present application.

### BACKGROUND OF THE INVENTION

### 1. Field of the Invention

The present invention relates to a laminate. More specifically, the present invention relates to a laminate including two optically anisotropic films.

The present invention also relates to a display device including the above-described laminate.

The present invention also relates to a wound roll.

### 2. Description of the Related Art

In recent years, a virtual reality display device has been put into practical use.

Examples of the virtual reality display device include a head mounted display including a display panel and a lens. In a case where such a head mounted display is mounted on a head of an observer and a video is displayed through the lens, the observer can visually recognize a realistic video.

In such a head mounted display, in order to reduce a thickness thereof, a lens using a reflective optical system may be adopted. As the reflective optical system, for example, a reflective type polarizer is used in a head mounted display as disclosed in JP2020-519964A.

### SUMMARY OF THE INVENTION

In the head mounted display (hereinafter, also referred to as HMD) disclosed in JP2020-519964A and the like, in a case of applying various members such as the reflective type polarizer, a portion of the various members is usually cut out according to a required size, and the cut-out member is adopted.

As a result of studying the HMD using the cut-out reflective type polarizer and the like as described above, the present inventors have found that a ghost (undesired image) may occur depending on the cutting position of the member, and that improvement is needed. That is, the present inventors have found that characteristics of the cut-out member vary in a case where cutting positions of the various members (laminate) are different.

Therefore, an object of the present invention is to provide a laminate from which a larger number of members capable of suppressing occurrence of a ghost in a case of being adopted to a head mounted display can be cut out.

Another object of the present invention is to provide a display device.

Still another object of the present invention is to provide a wound roll.

The present inventors have completed the present invention as a result of intensive studies to solve the above-described problems. That is, the present inventors have found that the above-described objects can be achieved by the following configuration.
[1] A laminate comprising:
a first optically anisotropic film; and
a second optically anisotropic film,
in which, in a case where, in a 50 cm×50 cm square region X within a plane of the laminate, an average orientation of directions in which an optical anisotropy of the first optically anisotropic film is largest at positions of a specific position group consisting of positions corresponding to vertices of the square, midpoint positions of sides of the square, and a centroid position of the square is defined as a first average orientation, and an average orientation of directions in which an optical anisotropy of the second optically anisotropic film is largest at each position of the specific position group in the region X is defined as a second average orientation,
   a maximum value among angles between the direction in which the optical anisotropy of the first optically anisotropic film is largest at each position of the specific position group and the first average orientation is in a range of 0.5° to 5.0°,
   an angle α between the first average orientation and the second average orientation satisfies a relationship of an expression (1), and
   in a case where an angle between a direction in which the optical anisotropy of the first optically anisotropic film is largest at any position in the region X and a direction in which the optical anisotropy of the second optically anisotropic film is largest at any position is defined as an angle β, all of the angles β at each position of the specific position group satisfy a relationship of an expression (2),

$$10 ° < α < 80 ° , \qquad the expression ( 1 )$$

$$0 ° \leq \vert β - α \vert 1 ° . \qquad the expression ( 2 )$$

[2] The laminate according to [1],
in which the laminate has an elongated shape.
[3] The laminate according to [2],
in which the first average orientation is 80° to 100° with respect to a longitudinal direction of the elongated shape.
[4] The laminate according to any one of [1] to [3],
in which the first optically anisotropic film is a stretching film.
[5] The laminate according to any one of [1] to [4],
in which the first optically anisotropic film is a reflective type linear polarizer.
[6] The laminate according to any one of [1] to [5],
in which an in-plane retardation of the second optically anisotropic film at a wavelength of 550 nm is 110 to 170 nm.
[7] The laminate according to any one of [1] to [6],
in which the angle α is 43° to 47°.
[8] The laminate according to any one of [1] to [7],
in which the second optically anisotropic film contains an aligned liquid crystal compound.
[9] The laminate according to any one of [1] to [8],
in which the second optically anisotropic film contains a twisted nematic aligned liquid crystal compound.
[10] The laminate according to any one of [1] to [9],
in which the first optically anisotropic film is adjacent to the second optically anisotropic film.
[11] The laminate according to any one of [1] to [10], further comprising:
a photoalignment layer between the first optically anisotropic film and the second optically anisotropic film.
[12] A display device comprising:
the laminate according to any one of [1] to [11].
[13] The display device according to [12],
in which the display device is a virtual reality display device.
[14] A wound roll comprising:
the laminate according to any one of [1] to [11],
in which the laminate having an elongated shape is wound.

According to the present invention, it is possible to provide a laminate from which a larger number of members capable of suppressing occurrence of a ghost in a case of being adopted to a head mounted display can be cut out.

In addition, according to the present invention, it is possible to provide a display device.

In addition, according to the present invention, it is possible to provide a wound roll.

### BRIEF DESCRIPTION OF THE DRAWINGS

FIG. 1 is a schematic cross-sectional view of an example of a laminate according to an embodiment of the present invention.

FIG. 2 is a top view of the laminate.

FIG. 3 is a bottom view of the laminate.

FIG. 4 is a schematic view showing an example of a configuration of a virtual reality display device.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Hereinafter, meaning of each description in the present specification will be explained.

In the present specification, a numerical range represented by “to” means a range including numerical values before and after “to” as a lower limit value and an upper limit value.

In the present specification, “absorption axis” denotes a polarization direction in which absorbance is maximized in a plane in a case where linearly polarized light is incident. In addition, “reflection axis” denotes a polarization direction in which reflectivity is maximized in a plane in a case where linearly polarized light is incident. In addition, a term “transmission axis” denotes a direction orthogonal to the absorption axis or the reflection axis in a plane. Furthermore, a term “in-plane slow axis” denotes a direction in which refractive index is maximized in a plane.

In the present specification, “orthogonal” and “parallel” are intended to include a range of errors acceptable in the art to which the present invention pertains. Specifically, it means that an angle is within an error range of the exact angle ±10°, and the error with respect to the exact angle is preferably within a range of ±5° and more preferably within a range of ±3°.

In addition, in the present specification, Re(λ) and Rth(λ) respectively represent an in-plane direction retardation at a wavelength λ and a thickness-direction retardation at a wavelength λ. Unless otherwise specified, the wavelength λ is 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d(μm)) in AxoScan, in-plane slow axis direction (°);

$$Re ( λ ) = R 0 ( λ ) ; and$$

$$Rth ( λ ) = ( ( nx + ny ) / 2 - nz ) \times d$$

are calculated.

Although R0(λ) is displayed as a numerical value calculated by AxoScan, it means Re(λ).

In addition, in the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene (1.59).

In the present specification, an A-plate and a C-plate are defined as follows.

There are two types of A-plates, a positive A-plate (A-plate which is positive) and a negative A-plate (A-plate which is negative). The positive A-plate satisfies a relationship of Expression (A1) and the negative A-plate satisfies a relationship of Expression (A2) in a case where a refractive index in a film in-plane slow axis direction (in a direction in which an in-plane refractive index is maximum) is denoted by nx, a refractive index in an in-plane direction orthogonal to the in-plane slow axis is denoted by ny, and a refractive index in a thickness direction is denoted by nz. The positive A-plate has an Rth showing a positive value and the negative A-plate has an Rth showing a negative value.

$$nx > ny \approx nz \qquad Expression ( A1 )$$

$$ny < nx \approx nz \qquad Expression ( A2 )$$

The symbol “≈” encompasses not only a case where both sides are completely the same as each other but also a case where the both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C-plates, a positive C-plate (C-plate which is positive) and a negative C-plate (C-plate which is negative). The positive C-plate satisfies a relationship of an expression (C1) and the negative C-plate satisfies a relationship of an expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where the both sides are substantially the same as each other. The expression “substantially the same” means that, for example, a case where (nx−ny)×d (in which d is a thickness of a film) is 0 to 10 nm and preferably 0 to 5 nm is also included in “nx≈ny”.

### <Laminate>

The laminate according to the embodiment of the present invention includes a first optically anisotropic film and a second optically anisotropic film.

In the laminate according to the embodiment of the present invention, in a case where, in a 50 cm×50 cm square region X within a plane, an average orientation of directions in which an optical anisotropy of the first optically anisotropic film is largest at positions of a specific position group consisting of positions corresponding to vertices of the square, midpoint positions of sides of the square, and a centroid position of the square is defined as a first average orientation, the maximum value among angles between the first average orientation and the direction in which the optical anisotropy of the first optically anisotropic film is largest at each position of the specific position group is in a range of 0.5° to 5.0°.

In addition, in the laminate according to the embodiment of the present invention, in a case where an average orientation of directions in which an optical anisotropy of the second optically anisotropic film is largest at each position of the specific position group in the region X is defined as a second average orientation, an angle α between the above-described first average orientation and the second average orientation satisfies a relationship of an expression (1), and an angle β between a direction in which the optical anisotropy of the first optically anisotropic film is largest at any position in the region X and a direction in which the optical anisotropy of the second optically anisotropic film is largest at any position satisfies a relationship of an expression (2) at each position of the specific position group.

$$10 ° < α < 80 ° \qquad Expression ( 1 )$$

$$0 ° \leq \vert β - α \vert 1 ° \qquad Expression ( 2 )$$

Hereinafter, the direction in which the optical anisotropy of the first optically anisotropic film is largest at any position in the region X is referred to as “first anisotropic orientation”; and the direction in which the optical anisotropy of the second optically anisotropic film is largest at any position in the region X is also referred to as “second anisotropic orientation”.

In the laminate according to the embodiment of the present invention, a mechanism by which a member which suppresses occurrence of a ghost in a case of being adopted to a head mounted display can be cut out more is not necessarily clear, but the present inventors have presumed as follows.

In the laminate according to the embodiment of the present invention, the maximum value among angles between the above-described first average orientation in the first optically anisotropic film and the first anisotropic orientation at each position of the specific position group is in a range of 0.5° to 5.0°. That is, in the first optically anisotropic film, the first average orientation and the first anisotropic orientation at any position of the specific position group are not strictly parallel (see FIG. 2).

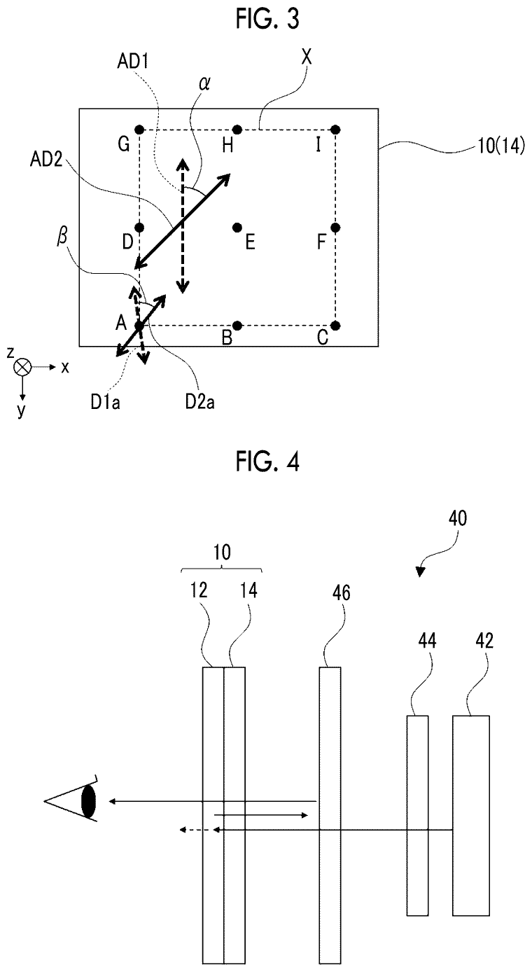

In addition, in the laminate according to the embodiment of the present invention, since the angle α between the second average orientation and the first average orientation satisfies the relationship of the expression (1), the laminate according to the embodiment of the present invention can exhibit desired optical characteristics. Here, in the laminate according to the embodiment of the present invention, the angle β between the first anisotropic orientation and the second anisotropic orientation at each position of the specific position group satisfy the relationship of the Expression (2) with the above-described angle α. In a case where the relationship of the expression (1) is satisfied and the relationship of the expression (2) is satisfied, it is represented that the above-described first average orientation and the first anisotropic orientation at any position of the specific position group are not strictly parallel, but the optical characteristics obtained by the relationship of the expression (1) are similarly satisfied at each position of the specific position group (see FIG. 3).

In this manner, it is considered that, in a case where the laminate according to the embodiment of the present invention is adopted to the HMD, the same optical characteristics are obtained at any position of the specific position group of the laminate, so that the member which suppresses occurrence of a ghost can be cut out more.

Hereinafter, an orientation relationship of the laminate according to the embodiment of the present invention will be described with reference to the drawings.

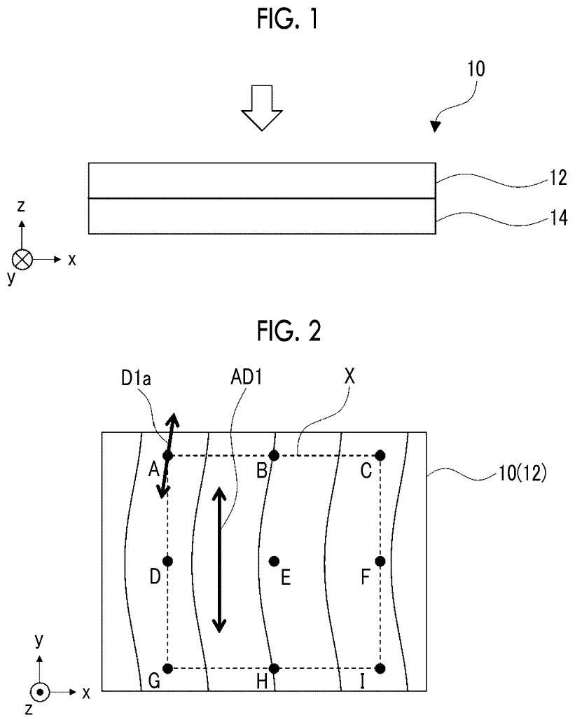

FIG. 1 shows a schematic cross-sectional view of an example of the laminate according to the embodiment of the present invention.

As shown in FIG. 1, a laminate 10 includes a first optically anisotropic film 12 and a second optically anisotropic film 14. As will be described later, the laminate 10 may include a member other than the first optically anisotropic film 12 and the second optically anisotropic film 14.

FIG. 2 is a top view of the laminate 10 as viewed from a direction of a white arrow in FIG. 1. That is, FIG. 2 is a view of the laminate 10 as viewed from the first optically anisotropic film 12 side, and the first optically anisotropic film 12 of the laminate 10 is observed in FIG. 2.

A curved solid line in the first optically anisotropic film 12 in FIG. 2 is a virtual representation of a distribution of the first anisotropic orientation (direction in which the optical anisotropy is largest) in an xy plane at each point in the plane of the first optically anisotropic film 12. As shown in FIG. 2, the first anisotropic orientation of the first optically anisotropic film 12 included in the laminate 10 according to the embodiment of the present invention is not uniform in the plane. In the aspect shown in FIG. 2, the first anisotropic orientation of the first optically anisotropic film 12 is oriented in an average manner in a y-axis direction of FIG. 2, but the first average orientation is inclined with respect to the y-axis direction at one end side and the other end side of the y-axis direction. Such inclination of the first average orientation is caused by, for example, a so-called bowing phenomenon. The bowing phenomenon is a phenomenon that may occur in a case of forming the first optically anisotropic film 12 by stretching, which will be described in detail later.

In addition, the region X defined by a dotted line in FIG. 2 is a region having a square shape of 50 cm×50 cm in the xy plane direction.

In the laminate 10 according to the embodiment of the present invention, the maximum value of angles between a first average orientation AD1, which is an average orientation of directions in which the optical anisotropy of the first optically anisotropic film 12 is largest at each position of the specific position group in the region X, and the above-described first anisotropic orientation at each position of the specific position group is in a range of 0.5° to 5.0°. Hereinafter, the relationship will be described.

Positions A to I in FIG. 2 are positions in the region X and correspond to each position of the specific position group described above. Positions A, C, G, and I are positions each corresponding to a vertex of the region X. Positions B, D, F, and H are each a midpoint position of a side of the region X. Position E is a centroid position of the region X (corresponding to an intersection of diagonals of the vertices). In FIG. 2, only a first anisotropic orientation D1a at the position A is shown as a representative, but first anisotropic orientations D1b to D1i are also provided at the positions B to I in the same manner as at the position A.

In FIG. 2, the first average orientation AD1, which is the average orientation of directions in which the optical anisotropy of the first optically anisotropic film 12 is largest at each position of the specific position group in the region X, is an average orientation of the first anisotropic orientations D1a to D1i described above, and is parallel to the y-axis direction as shown in FIG. 2.

In this case, in the laminate 10 according to the embodiment of the present invention, the maximum value of angles between the first average orientation AD1 and the first anisotropic orientations D1a to D1i described above is in a range of 0.5° to 5.0°.

FIG. 3 is a bottom view of the laminate 10 as viewed from a side opposite to the direction of the white arrow in FIG. 1. That is, FIG. 3 is a view of the laminate 10 as viewed from the second optically anisotropic film 14 side, and the second optically anisotropic film 14 of the laminate 10 is observed in FIG. 3.

In addition, FIG. 3 shows the region X at positions corresponding to the above-described positions A to I in FIG. 2. Hereinafter, the relationships of the expression (1) and the expression (2) will be described.

The second optically anisotropic film 14 has a second anisotropic orientation (not shown) at each point in the plane. In FIG. 3, only a second anisotropic orientation D2a at the position A is shown as a representative, but second anisotropic orientations D2b to D2i are also provided at the positions B to I in the same manner as at the position A. In FIG. 3, the second average orientation AD2, which is the average orientation of directions in which the optical anisotropy of the second optically anisotropic film 14 is largest at each position of the specific position group in the region X, is an average orientation of the second anisotropic orientations D2a to D2i described above.

In addition, in FIG. 3, the first average orientation AD1 and the first anisotropic orientation D1a at the position A, which are shown in FIG. 2, are shown by a dotted line.

Here, in a case where an angle between the first average orientation AD1 and the second average orientation AD2 is defined as an angle α, the laminate 10 according to the embodiment of the present invention satisfies the following relationship of the expression (1).

$$10 ° < α < 80 ° \qquad Expression ( 1 )$$

In addition, in a case where an angle between the above-described second anisotropic orientation D2a and the above-described first anisotropic orientation D1a is defined as an angle β, the laminate 10 according to the embodiment of the present invention satisfies the following relationship of the expression (2).

$$0 ° \leq \vert β - α \vert 1 ° \qquad Expression ( 2 )$$

Here, in the laminate 10 according to the embodiment of the present invention, the fact that the angle β calculated at each position of the specific position group satisfies the relationship of the expression (2) means that the angle β calculated at each of the above-described positions A to I satisfies the relationship of the expression (2).

In the laminate 10 according to the embodiment of the present invention, since the maximum value of the angles between the first average orientation AD1 and the above-described first anisotropic orientations D1a to D1i is in a range of 0.5° to 5.0°, and the relationships of the expression (1) and the expression (2) are satisfied, it is considered that the occurrence of a ghost is suppressed in a case where the laminate 10 is adopted to the head mounted display by the above-described mechanism.

The direction of the first anisotropic orientation (first anisotropic orientations D1a to D1i) of the first optically anisotropic film 12 at the above-described positions A to I can be measured using an AxoScan (polarimeter) device manufactured by Axometrics, Inc. and analysis software manufactured by Axometrics, Inc.

In addition, the direction of the second anisotropic orientation (second anisotropic orientations D2a to D2i) of the second optically anisotropic film 14 at the above-described positions A to I can be measured by the same method as the first anisotropic orientation.

A shape of the laminate 10 is not particularly limited, but is preferably an elongated shape.

In a case where the laminate 10 has an elongated shape, the laminate 10 may be wound to form a wound roll.

In addition, in a case where the laminate 10 has an elongated shape, the above-described first average orientation (first average orientation AD1 in FIG. 2) is preferably 80° to 100° and more preferably 85° to 95° with respect to a longitudinal direction (lengthwise direction) of the elongated shape.

The angle α, which is the angle between the first average orientation AD1 and the second average orientation AD2, is preferably 15° to 75°, more preferably 25° to 60°, still more preferably 40° to 50°, and particularly preferably 43° to 47°. Re(550), which is an in-plane retardation of the second optically anisotropic film 14 at a wavelength of 550 nm, is preferably 110 to 170 nm, more preferably 120 to 160 nm, still more preferably 125 to 160 nm, and particularly preferably 130 to 150 nm.

The laminate 10 has a size of more than 50 cm×50 cm.

In the laminate 10 according to the aspect shown in FIG. 1, the first optically anisotropic film 12 and the second optically anisotropic film 14 are adjacent to each other, but the laminate according to the embodiment of the present invention may include another layer between the first optically anisotropic film and the second optically anisotropic film. Examples of other layers include an alignment layer (more preferably, a photoalignment layer) described later.

Hereinafter, configurations which may be included in the first optically anisotropic film, the second optically anisotropic film, and the laminate according to the embodiment of the present invention will be described.

### [First Optically Anisotropic Film]

The laminate according to the embodiment of the present invention includes a first optically anisotropic film.

As described above, in the first optically anisotropic film, the maximum value of angles between the first average orientation in the region X and the first anisotropic orientation at each position of the specific position group is in a range of 0.5° to 5.0°.

The first optically anisotropic film is not particularly limited as long as the above-described requirement is satisfied, but is preferably a polarizer. The polarizer is preferably a linear polarizer. Examples of the linear polarizer include a reflective type linear polarizer and an absorptive type linear polarizer, and a reflective type linear polarizer is preferable.

Hereinafter, the reflective type linear polarizer and the absorptive type linear polarizer will be described as the first optically anisotropic film.

### (Reflective Type Linear Polarizer)

The reflective type linear polarizer is a linear polarizer which transmits linearly polarized light in a certain direction (transmission axis direction) and reflects linearly polarized light in a direction (reflection axis direction) orthogonal to the linearly polarized light. In the reflective type linear polarizer, the direction in which the optical anisotropy is largest (first anisotropic orientation) is the reflection axis direction.

As the reflective type linear polarizer, known reflective type linear polarizers can be used as long as it selectively transmits linearly polarized light in a certain direction in a wavelength range of visible light.

Examples of the reflective type linear polarizer include a film obtained by stretching a dielectric multi-layer film as described in JP2011-053705A and the like.

In addition, as the reflective type linear polarizer, a commercially available product can be suitably used. Examples of the commercially available product of the reflective type linear polarizer include a reflective type linear polarizer (trade name: APF) manufactured by 3M.

In the reflective type linear polarizer, which is the stretched film as described above, the reflection axis may be non-uniform in the in-plane direction of the film during stretching. More specifically, the reflective type linear polarizer as the stretched film is often formed by stretching in a direction orthogonal to a transport direction, and a so-called bowing phenomenon is likely to occur. In a case where the bowing phenomenon occurs, an alignment state of molecules is different between a center portion and an end portion of the stretched film in the width direction, and as a result, the direction of the reflection axis is likely to vary depending on the in-plane position.

In a case where such a reflective type linear polarizer is used as the first optically anisotropic film, the maximum value of the angles between the first average orientation in the region X and the first anisotropic orientation at each position of the specific position group is likely to be in a range of 0.5° to 5.0°.

### (Absorption Type Linear Polarizer)

The absorption type linear polarizer is a linear polarizer which transmits linearly polarized light in a certain direction (transmission axis direction) and absorbs linearly polarized light in a direction (absorption axis direction) orthogonal to the linearly polarized light. In the absorption type linear polarizer, the direction in which the optical anisotropy is largest (first anisotropic orientation) is the absorption axis direction.

As the absorption type linear polarizer, a general polarizer can be used. For example, a polarizer in which a dichroic substance is dyed on polyvinyl alcohol and another polymer resin and is stretched so that the dichroic substance is aligned may be used, or a polarizer in which a dichroic substance is aligned by using alignment of a liquid crystal compound may be used.

Among these, in a case where an absorption type linear polarizer formed by stretching is used as the first optically anisotropic film, the maximum value of the angles between the first average orientation in the region X and the first anisotropic orientation at each position of the specific position group is likely to be in a range of 0.5° to 5.0°.

The absorption type linear polarizer may contain a liquid crystal compound and a dichroic substance. The absorption type linear polarizer containing the liquid crystal compound and the dichroic substance may be a coating type polarizer. The coating type polarizer means a polarizer which can be formed by applying a composition containing the liquid crystal compound and the dichroic substance.

The absorption type linear polarizer may be an absorption type linear polarizer obtained by applying a composition containing a liquid crystal compound having a polymerizable group and a dichroic substance, aligning the liquid crystal compound, and polymerizing the polymerizable group to fix the alignment state of the liquid crystal compound.

### [Second Optically Anisotropic Film]

The laminate according to the embodiment of the present invention includes a second optically anisotropic film.

In the second optically anisotropic film, the relationships of the expression (1) and the expression (2) are satisfied in relation to the first optically anisotropic film.

The second optically anisotropic film is not particularly limited as long as the above-described requirements are satisfied in relation to the first optically anisotropic film, but the second optically anisotropic film is preferably a retardation film having an in-plane retardation. In a case where the second optically anisotropic film is a retardation film, the direction in which the optical anisotropy of the second optically anisotropic film is largest (second anisotropic orientation) is the in-plane slow axis direction.

In a case where the retardation film is used as the second optically anisotropic film and the linear polarizer is used as the first optically anisotropic film, the above-described angle α (angle between the first average orientation and the second average orientation) satisfies the relationship of the expression (1), so that the laminate according to the embodiment of the present invention can function as an elliptically polarizing plate.

In addition, in a case where the retardation film is used as the second optically anisotropic film and the reflective type linear polarizer is used as the first optically anisotropic film, the laminate according to the embodiment of the present invention can function as a reflective elliptically polarizing plate.

In a case where the second optically anisotropic film is a retardation film, the retardation film is preferably a λ/4 plate. The λ/4 plate is a plate having a λ/4 function, specifically, a plate having a function of converting linearly polarized light having a specific wavelength (preferably, visible light) into circularly polarized light (or converting circularly polarized light into linearly polarized light).

An in-plane retardation (Re(550)) of the second optically anisotropic film at a wavelength of 550 nm is preferably 110 to 170 nm, more preferably 120 to 160 nm, still more preferably 125 to 160 nm, and particularly preferably 130 to 150 nm.

In addition to the λ/4 plate, a retardation film in which an in-plane retardation at a wavelength of 550 nm is 3/4 or 5/4 of a wavelength of any light of visible light is also preferable.

In a case where the retardation film which is the λ/4 plate is used as the second optically anisotropic film and the linear polarizer is used as the first optically anisotropic film, the laminate according to the embodiment of the present invention can function as a circular polarization plate. In this case, the above-described angle α is preferably 15° to 75°, more preferably 25° to 60°, still more preferably 35° to 55°, particularly preferably 40° to 50°, more particularly preferably 43° to 47°, and most preferably 44° to 46°. The angle α may be 45°.

In addition, in a case where the second optically anisotropic film contains a twistedly aligned (more preferably twisted nematic aligned) liquid crystal compound, the above-described angle α is preferably 25° to 60°, more preferably 25° to 50°, and still more preferably 25° to 46°.

The retardation film may have reverse wavelength dispersibility. The expression “having reverse wavelength dispersibility” denotes that as the wavelength increases, the value of the phase difference at the wavelength increases. Specifically, Re(450)/Re(550) of the retardation film is preferably 0.70 or more and less than 1.00, and more preferably 0.80 to 0.90. In addition, Re(650)/Re(550) of the retardation film is preferably more than 1.00 and 1.20 or less, and more preferably 1.01 to 1.10.

In addition, the retardation film may have a multilayer structure, and specific examples thereof include a broadband λ/4 plate obtained by laminating a λ/4 plate and a λ/2 plate. The λ/2 plate is a plate having a λ/2 function, and specifically, is a plate having a function of converting linearly polarized light at a specific wavelength (preferably, visible light) into linearly polarized light in an orthogonal direction.

The second optically anisotropic film preferably contains a liquid crystal compound, and a film in which an alignment direction of the liquid crystal compound is fixed is more preferable. In a case where the second optically anisotropic film contains a liquid crystal compound, the liquid crystal compound may no longer exhibit liquid crystallinity in the second optically anisotropic film.

The “fixed” state is a state in which the alignment of a liquid crystal compound is maintained. Specifically, the “fixed” state is preferably a state in which, in a temperature range of usually 0° C. to 50° C. or in a temperature range of −30° C. to 70° C. under more severe conditions, the layer has no fluidity and a fixed alignment morphology can be stably maintained without causing a change in the alignment morphology due to an external field or an external force.

The liquid crystal compound may be a rod-like liquid crystal compound or a disk-like liquid crystal compound. In addition, the liquid crystal compound may be of a low-molecular-weight type or a high-molecular-weight type. The “high-molecular-weight” generally refers to a compound having a degree of polymerization of 100 or more (Polymer Physics-Phase Transition Dynamics, written by Masao Doi, p. 2, published by Iwanami Shoten, 1992). In the second optically anisotropic film, any liquid crystal compound can be used, but a rod-like liquid crystal compound or a disk-like liquid crystal compound is preferably used, and a rod-like liquid crystal compound is more preferably used. A mixture of two or more kinds of the rod-like liquid crystal compounds, two or more kinds of the disk-like liquid crystal compounds, or a mixture of the rod-like liquid crystal compound and the disk-like liquid crystal compound may be used.

For example, a rod-like liquid crystal compound described in claim 1 of JP1999-513019A (JP-H11-513019A) or a rod-like liquid crystal compound described in paragraphs 0026 to 0098 of JP2005-289980A can be preferably used as the rod-like liquid crystal compound.

As the disk-like liquid crystal compound, for example, compounds described in paragraphs 0020 to “0067” of JP2007-108732A and 0013 to 0108 of JP2010-244038A can be preferably used.

In addition, the disk-like liquid crystal compound may have a polymerizable group. In a case where the liquid crystal compound has a polymerizable group, the liquid crystal compounds are polymerized with each other or the liquid crystal compound is polymerized with another compound through the polymerizable group, so that the alignment of the liquid crystal compound can be fixed. The liquid crystal compound having a polymerizable group is also referred to as a polymerizable liquid crystal compound.

The polymerizable group is not particularly limited, but is preferably a functional group capable of an addition polymerization reaction, more preferably a polymerizable ethylenically unsaturated group or a ring-polymerizable group, and still more preferably a (meth)acryloyl group, a vinyl group, a styryl group, or an allyl group.

After the liquid crystal compound is immobilized by polymerization or the like to form the second optically anisotropic film, the liquid crystal compound may no longer exhibit liquid crystallinity.

The alignment of the liquid crystal compound is not particularly limited as long as the second optically anisotropic film satisfies the relationships of the expression (1) and the expression (2) in relation to the first optically anisotropic film.

In a case where the liquid crystal compound includes the rod-like liquid crystal compound, as an alignment direction of the liquid crystal compound, the rod-like liquid crystal compound is preferably horizontally aligned. The state in which the rod-like liquid crystal compound is horizontally aligned means that a major axis of the rod-like liquid crystal compound and a main surface of the second optically anisotropic film are parallel to each other. It is not required to be strictly parallel, but an angle formed by the major axis of the rod-like liquid crystal compound and the main surface of the second optically anisotropic film is preferably in a range of 0°±20° and more preferably in a range of 0°±10°.

In addition, in a case where the liquid crystal compound includes the disk-like liquid crystal compound, as an alignment direction of the liquid crystal compound, the disk-like liquid crystal compound is preferably vertically aligned. The state in which the disk-like liquid crystal compound is vertically aligned means that a disc plane of the disk-like liquid crystal compound is perpendicular to a main surface of the second optically anisotropic film. It is not required to be strictly perpendicular, but an angle formed by the disc plane of the disk-like liquid crystal compound and the main surface of the second optically anisotropic film is preferably in a range of 90°±20° and preferably in a range of 90°±10°.

In addition, in a case where the second optically anisotropic film contains a liquid crystal compound, the liquid crystal compound is preferably twistedly aligned, and the liquid crystal compound is more preferably twisted nematic aligned.

The twisted alignment (more preferably, twisted nematic alignment) is preferably twisted alignment with a thickness direction of the second optically anisotropic film as a helical axis.

The second optically anisotropic film containing the above-described twistedly aligned (more preferably twisted nematic aligned) liquid crystal compound can be formed of, for example, a liquid crystal composition containing a liquid crystal compound and a chiral agent.

The chiral agent refers to a compound which can induce the twisted alignment of the liquid crystal compound. The chiral agent may or may not change a capability (helical twisting power) of inducing the twisted alignment by light irradiation. In addition, a direction of the helical twisting power is not particularly limited.

In addition, the chiral agent may or may not exhibit liquid crystallinity.

Examples of the chiral agent (photoreactive chiral agent) in which the helical twisting power changes by light irradiation include a compound having a chiral site and a photoreactive site which changes in structure by the light irradiation, and examples thereof also include a compound which greatly changes the twisting power of the liquid crystal compound depending on an irradiation amount. Examples of the photoreactive site in which structure changes due to irradiation with light include photochromic compounds (Kingo Uchida and Masahiro Irie, Chemical Industry, vol. 64, p. 640, 1999, and Kingo Uchida and Masahiro Irie, Fine Chemical, vol. 28 (9), p. 15, 1999). In addition, the above-described structural change means decomposition, addition reaction, isomerization, racemization, [2+2] photocyclization, dimerization, or the like occurred upon light irradiation of the photoreactive site, and the structural change may be irreversible. In addition, the chiral site corresponds to, for example, the asymmetric carbon described in Hiroyuki Nohira, Chemical Review, No. 22, Chemistry of Liquid Crystals, p. 73, 1994.

Two or more kinds of the above-described chiral agents may be used at the same time, and a photoreactive chiral agent and a non-photoreactive chiral agent may be used in combination.

In a case where the second optically anisotropic film contains a twistedly aligned (more preferably twisted nematic aligned) liquid crystal compound, the alignment direction of the liquid crystal compound on a surface of the second optically anisotropic film on the first optically anisotropic film side is preferably parallel to the first anisotropic orientation at each point of the first optically anisotropic film.

### [Alignment Layer]

The laminate according to the embodiment of the present invention may include an alignment layer.

The alignment layer can be formed by methods such as rubbing treatment of an organic compound (preferably a polymer), oblique vapor deposition of an inorganic compound, formation of a layer having microgrooves, or accumulation of an organic compound (for example, ω-tricosanoic acid, dioctadecylmethylammonium chloride, or methyl stearate) by the Langmuir-Blodgett method (LB film).

Furthermore, an alignment layer capable of providing an alignment function by application of an electric field, application of a magnetic field, or irradiation with light (preferably polarized light) is also known. That is, the alignment layer may be a photoalignment layer.

The alignment layer is also preferably formed by a rubbing treatment of a polymer.

It is preferable that the alignment layer is disposed adjacent to the second optically anisotropic film. In particular, in a case where the second optically anisotropic film contains a liquid crystal compound, the alignment layer can control the alignment direction of the liquid crystal compound.

In a case where the alignment layer is a photoalignment layer, it is preferable that the alignment layer is disposed between the first optically anisotropic film and the second optically anisotropic film.

In a case of forming the photoalignment layer, a layer containing a component capable of forming the photoalignment layer may be formed on one surface of the first optically anisotropic film, and then the photoalignment layer may be formed by irradiating the layer with unpolarized light from the other surface side. In a case where the photoalignment layer is formed by the above-described procedure, a photoalignment layer having an alignment restriction force corresponding to the distribution of the first anisotropic orientation of the first optically anisotropic film can be formed.

A thickness of the alignment layer is not particularly limited as long as it can exhibit an alignment function, but is preferably 0.01 to 5.0 μm, more preferably 0.05 to 2.0 μm, and still more preferably 0.1 to 0.5 μm.

### [Substrate]

The laminate according to the embodiment of the present invention may further include a substrate.

The substrate is preferably a transparent substrate. The transparent substrate is intended to be a substrate in which the transmittance of visible light is 60% or more, and the transmittance is preferably 80% or more and more preferably 90% or more. The upper limit thereof is not particularly limited, and is preferably 99.9% or less.

A thickness of the substrate is not particularly limited, but is preferably 10 to 200 μm, more preferably 10 to 100 μm, and still more preferably 20 to 90 μm.

In addition, the substrate may consist of a plurality of layers laminated. The substrate may be subjected to a surface treatment (for example, a glow discharge treatment, a corona discharge treatment, an ultraviolet (UV) treatment, or a flame treatment) on the surface of the substrate in order to improve adhesion with a layer provided thereon.

In addition, an adhesive layer (undercoat layer) may be provided on the substrate.

The substrate may be a so-called temporary support. For example, after manufacturing the first optically anisotropic film and the second optically anisotropic film on the substrate, the substrate may be peeled off from the optically anisotropic layer as necessary.

### [Adhesion Layer]

The laminate according to the embodiment of the present invention may include an adhesion layer.

Examples of the adhesion layer include known pressure sensitive adhesive layers and adhesive layers.

The adhesive layer is a layer formed of an adhesive. Examples of the adhesive include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet curable adhesive, and a visible light-curable adhesive.

The pressure sensitive adhesive layer is a layer formed of a pressure sensitive adhesive. Examples of the pressure sensitive adhesive include a rubber-based pressure sensitive adhesive, an acrylic pressure sensitive adhesive, a silicone-based pressure sensitive adhesive, a urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive.

### [Other Optically Anisotropic Layers]

The laminate according to the embodiment of the present invention may further include an optically anisotropic layer other than the first optically anisotropic film and the second optically anisotropic film described above.

Examples of other optically anisotropic layers include a positive A-plate, a negative A-plate, a positive C-plate, and a negative C-plate.

The other optically anisotropic layers are appropriately selected according to desired optical characteristics. Two or more of the other optically anisotropic layers may be used.

### [Antireflection Layer]

The laminate according to the embodiment of the present invention may include an antireflection layer. It is preferable that the antireflection layer is disposed on the outermost surface side of the laminate. The antireflection layer may be disposed only on one surface side of the laminate, or may be disposed on both surface sides of the laminate.

A known antireflection layer can be adopted as the antireflection layer, and the type thereof is not particularly limited. Among these, from the viewpoint of further reducing reflectivity, a moth-eye film or an antireflection (AR) film is preferable.

### <Manufacturing Method of Laminate>

A manufacturing method of the laminate according to the embodiment of the present invention is not particularly limited as long as a laminate satisfying the above-described requirements is manufactured.

Examples of the manufacturing method of the laminate according to the embodiment of the present invention include the following first embodiment, second embodiment, and third embodiment.

Examples of a first embodiment of the manufacturing method of the laminate according to the embodiment of the present invention include a method of preparing the first optically anisotropic film satisfying the above-described requirement, forming a photoalignment layer on one surface of the first optically anisotropic film, applying a liquid crystal composition containing a liquid crystal compound to a side of the photoalignment layer opposite to the first optically anisotropic film side to form a coating layer L, and performing an alignment treatment on the coating layer L to form the second optically anisotropic film.

Hereinafter, each step of the first embodiment will be described in detail.

First, the first optically anisotropic film is prepared. The first optically anisotropic film is not particularly limited as long as the above-described requirement is satisfied, but can be manufactured by, for example, a manufacturing method including a stretching step.

Next, the photoalignment layer is formed on one surface of the first optically anisotropic film.

A method of forming the photoalignment layer is not particularly limited, but examples thereof include a method of applying a composition for forming the photoalignment layer, containing a component capable of forming the photoalignment layer described above, to one surface of the first optically anisotropic film to form a coating layer P, and irradiating the coating layer P with polarized light (preferably, linearly polarized light).

In this case, it is preferable that the linearly polarized light to be irradiated is in a direction corresponding to the first anisotropic orientation at each point in the plane of the first optically anisotropic film. For example, in a case where the angle α, which is the angle between the first average orientation and the second average orientation described above, is 45°, it is preferable to adjust the orientation of the linearly polarized light to be irradiated such that the angle between the first anisotropic orientation and the second anisotropic orientation at each point of the first optically anisotropic film is 45°±1°. The first anisotropic orientation at each point of the first optically anisotropic film can be measured by the above-described method, and the orientation of the linearly polarized light to be irradiated can be adjusted according to the measured first anisotropic orientation.

In addition, as will be described in detail later, in a case where the second optically anisotropic film contains a twisted nematic aligned liquid crystal compound, the orientation of the linearly polarized light to be irradiated may be adjusted such that the angle between the first anisotropic orientation and the second anisotropic orientation is 0°±1°.

Examples of the above-described adjustment of the orientation of the linearly polarized light to be irradiated include a method of using a linear polarizer as the first optically anisotropic film and irradiating the coating layer P of the first optically anisotropic film with unpolarized light from a side opposite to the surface on which the coating layer P is formed. According to the above-described procedure, linearly polarized light in a polarization direction corresponding to a direction orthogonal to the first anisotropic orientation (reflection axis direction or absorption axis direction of the linear polarizer) at each point of the first optically anisotropic film is incident on the coating layer P, and the photoalignment layer having an alignment restriction force along a direction corresponding to the first anisotropic orientation at each point is formed.

In addition, examples of the above-described adjustment of the orientation of the linearly polarized light to be irradiated include a method of inserting a linear polarizer having a predetermined size between a light source emitting unpolarized light and the coating layer P, and irradiating the coating layer P with the linearly polarized light. In this case, the orientation of the inserted linear polarizer is adjusted in a direction in which the alignment restriction force of the photoalignment layer is to be generated, and the coating layer P is irradiated with the linearly polarized light for each predetermined region. More specifically, a linear polarizer having an area smaller than an area of the coating layer P may be disposed between the coating layer P and the light source, and the linearly polarized light may be irradiated through the linear polarizer while moving a position of the linear polarizer and changing an orientation of a polarization direction of the linear polarizer, and the alignment restriction force may be applied in a direction corresponding to the first anisotropic orientation at each point.

Next, a liquid crystal composition containing a liquid crystal compound is applied to a side of the photoalignment layer opposite to the first optically anisotropic film side to form the coating layer L.

The liquid crystal compound contained in the liquid crystal composition can be the above-described liquid crystal compound. In addition, the liquid crystal composition may contain the above-described chiral agent. The liquid crystal composition may further contain a solvent.

Examples of the method of applying the liquid crystal composition include known methods such as a roll coating method, a gravure printing method, a spin coating method, a wire bar coating method, an extrusion coating method, a direct gravure coating method, a reverse gravure coating method, a die-coating method, a spraying method, and an ink jet method.

Next, a treatment of aligning the liquid crystal compound in the coating layer L is performed. By the alignment treatment, the liquid crystal compound is aligned along the alignment restriction force of the photoalignment layer, and the laminate according to the embodiment of the present invention satisfying the above-described expression (1) and expression (2) is obtained.

The alignment treatment may include a drying treatment. Components such as a solvent can be removed from the coating layer L by performing the drying treatment. The drying treatment may be performed by a method of allowing the coating layer L to stand at room temperature for a predetermined time (for example, natural drying) or a method of heating the coating layer L and/or blowing air to the coating layer L.

In a case where the drying treatment is performed at a temperature equal to or higher than a transition temperature of the liquid crystal compound contained in the coating layer L from a liquid crystal phase to an isotropic phase, a heat treatment described below may not be performed.

It is preferable that the alignment treatment includes a heat treatment. As a result, the liquid crystal compound contained in the coating layer L can be aligned.

From the viewpoint of manufacturing suitability, a heat temperature is preferably 20° C. to 250° C. and more preferably 25° C. to 190° C. In addition, the heating time is preferably 1 to 300 seconds and more preferably 1 to 60 seconds.

The alignment treatment may include a cooling treatment performed after the heat treatment. The cooling treatment is a treatment of cooling the coating layer L after the heating. As a result, the alignment of the liquid crystal compound contained in the coating layer L can be fixed. A cooling unit is not particularly limited, and the cooling treatment can be performed according to a known method. As the cooling temperature, the optimum temperature is selected depending on the liquid crystal compound used.

In a case where the liquid crystal compound has a polymerizable group, a curing treatment may be performed as necessary. Examples of the curing treatment include a light irradiation treatment.

According to the above-described first embodiment, a laminate including the photoalignment layer between the first optically anisotropic film and the second optically anisotropic film is obtained.

Examples of a second embodiment of the manufacturing method of the laminate according to the embodiment of the present invention include a method of preparing the first optically anisotropic film satisfying the above-described requirement, applying a liquid crystal composition containing a liquid crystal compound onto one surface of the first optically anisotropic film to form a coating layer L, and performing an alignment treatment on the coating layer L to form the second optically anisotropic film.

In many cases, in the first optically anisotropic film, molecules of a compound constituting the first optically anisotropic film are aligned on the surface thereof in accordance with the first anisotropic orientation at each point in the plane, and the first optically anisotropic film has an alignment restriction force. In this case, in a case where the liquid crystal composition is applied onto the surface of the first optically anisotropic film to form the coating layer L, and then the alignment treatment is performed on the coating layer L, the liquid crystal compound is aligned in accordance with the alignment direction of the molecules on the surface of the first optically anisotropic film.

In the second embodiment of the manufacturing method of the laminate according to the embodiment of the present invention, it is preferable that the liquid crystal composition contains a chiral agent, and it is preferable that the second optically anisotropic film to be formed contains a twistedly aligned (more preferably twisted nematic aligned) liquid crystal compound. In a case where the second optically anisotropic film contains a twistedly aligned liquid crystal compound, the angle α is easily adjusted to satisfy the expression (1) described above.

In the second embodiment of the manufacturing method of the laminate according to the embodiment of the present invention, preferred aspects of the method of forming the coating layer L, the alignment treatment, and other treatments are the same as those in the first embodiment, and thus the description thereof will not be repeated.

According to the above-described second embodiment, a laminate in which the first optically anisotropic film is adjacent to the second optically anisotropic film is obtained.

Examples of a third embodiment of the manufacturing method of the laminate according to the embodiment of the present invention include a method of preparing the first optically anisotropic film satisfying the above-described requirement, and bonding the first optically anisotropic film to a separately obtained second optically anisotropic film. In a case of bonding, the second anisotropic orientation at each point of the second optically anisotropic film and the orientation relationship of the film during bonding are adjusted to satisfy the above-described expression (1) and expression (2).

The second anisotropic orientation at each point of the second optically anisotropic film may be adjusted, for example, by measuring the first anisotropic orientation at each point of the first optically anisotropic film and setting the second anisotropic orientation in accordance with the first anisotropic orientation at each point. Examples of the adjustment method include the methods described in the first embodiment.

The first optically anisotropic film and the second optically anisotropic film are bonded to each other, for example, through the above-described adhesion layer. A photoalignment layer may be used in a case of forming the second optically anisotropic film, and the photoalignment layer may be removed or may not be removed in a case of bonding.

The above-described aspects other than the above-described aspects can be implemented in the same manner as in the first embodiment and the second embodiment, and thus the description thereof will not be repeated.

According to the above-described third embodiment, a laminate including the adhesion layer between the first optically anisotropic film and the second optically anisotropic film is obtained.

The laminate obtained by the above-described manufacturing methods may be further subjected to a treatment of being processed into a non-planar shape. That is, the laminate according to the embodiment of the present invention may have a non-planar shape portion. In the laminate, the entire film may be the non-planar shape portion, or a part of the laminate may be the non-planar shape portion. In a case where a part of the laminate is the non-planar shape portion, the other part may be a planar shape portion.

The non-planar shape portion means a portion having a non-planar shape. The non-planar shape means a shape other than a planar shape, and examples thereof include a curved surface shape. That is, the non-planar shape portion may be a curved surface shape portion.

The above-described curved surface shape means a shape having a curvature of more than 0, and includes a curved surface shape which is a developable surface and a three-dimensional curved surface shape. The developable surface is a surface which is developable onto a plane without stretching or contracting any part of the surface.

Examples of the curved surface shape which is a developable surface include surfaces corresponding to a cylindrical peripheral surface, an elliptical cylindrical peripheral surface, a conical peripheral surface, an elliptical conical peripheral surface, and the like; and the curved surface shape may be a convex curved surface or a concave curved surface. The three-dimensional curved surface shape is a curved surface which cannot be produced by deformation of a plane, that is, a curved surface which is not developable, and examples thereof include surfaces corresponding to a spherical surface, a rotational ellipsoid surface, and surfaces where the cross-section forms a parabola or hyperbola (for example, a rotational parabolic surface). The three-dimensional curved surface shape may be a convex curved surface or a concave curved surface.

The curved surface shape is preferably lens-like. Examples of the lens-like curved surface shape include a spherical surface shape and revolution body shapes such as a rotational ellipsoid surface shape; and the lens-like curved surface shape may be a convex lens-like shape or a concave lens-like shape.

In a case where the non-planar shape portion in the laminate has a curved surface shape (in a case where the non-planar shape portion is a curved surface shape portion), a curvature radius of the non-planar shape portion in the laminate is not particularly limited, but is preferably 20 to 80 mm, more preferably 30 to 80 mm, and still more preferably 35 to 60 mm.

The curvature radius of the non-planar shape portion in the laminate may be constant or may vary at any position of the non-planar shape portion, and it is preferable that the curvature radius at any position is within the above-described range. In a case where the curvature radius is constant at any position of the non-planar shape portion, the shape of the non-planar shape portion corresponds to a spherical shape.

In a case where the non-planar shape portion in the laminate has a curved surface shape (the non-planar shape portion is a curved surface shape portion), the minimum curvature radius of the non-planar shape portion in the laminate is not particularly limited, but from the viewpoint that the effect of the present invention is more excellent, it is preferably 30 to 80 mm and more preferably 35 to 60 mm.

In a case where the non-planar shape portion in the laminate has a curved surface shape (in a case where the non-planar shape portion is a curved surface shape portion), the maximum curvature radius of the non-planar shape portion in the laminate is not particularly limited, but is preferably 35 to 80 mm and more preferably 35 to 60 mm.

In a case where the curved surface shape of the non-planar shape portion in the laminate is a spherical shape, or revolution body shapes such as a rotational ellipsoidal shape and a rotational parabolic surface shape, a size of the non-planar shape portion in a case of being seen in a plan view from a rotation axis direction of these shapes is not particularly limited, and an equivalent circle diameter of the non-planar shape portion is preferably 30 to 80 mm and more preferably 40 to 60 mm.

The equivalent circle diameter is a diameter of a virtual perfect circle assumed to have the same projected area as the projected area of the non-planar shape portion observed.

### <Display Device (Virtual Reality Display Device)>

The laminate according to the embodiment of the present invention can be applied to various display devices, and is preferably applied to a virtual reality display device.

FIG. 4 is a schematic view showing an example of a configuration of the virtual reality display device.

A virtual reality display device 40 shown in FIG. 4 includes, from the right side in the drawing, an image display panel 42, a circular polarization plate 44, a half mirror 46, and the laminate 10 according to the embodiment of the present invention. The laminate 10 used in FIG. 4 has the same configuration as the laminate 10 shown in FIG. 1, and the laminate 10 has a function of a reflective type circular polarization polarizer. That is, in the aspect shown in FIG. 4, the first optically anisotropic film 12 is a reflective type linear polarizer, the second optically anisotropic film 14 has a function of a λ/4 plate, and the above-described angle α is 45°. In addition, the laminate 10 used in FIG. 4 is a member in which a part is cut out from the laminate according to the embodiment of the present invention to match a shape of the virtual reality display device 40.

In the virtual reality display device 40 shown in FIG. 4, light emitted from the image display panel 42 is transmitted through the circular polarization plate 44 to be circularly polarized light, and a part of the light is transmitted through the half mirror 46. The circularly polarized light transmitted through the half mirror 46 is incident on the second optically anisotropic film 14 included in the laminate 10 according to the embodiment of the present invention, is converted into linearly polarized light, and is reflected by the first optically anisotropic film 12 (reflective type linear polarizer). The linearly polarized light reflected by the first optically anisotropic film 12 transmits through the second optically anisotropic film 14 to be circularly polarized light again, and is reflected by the half mirror 46. In a case where the circularly polarized light is reflected by the half mirror 46, a phase thereof is reversed, so that a sense of rotation of the circularly polarized light reflected by the half mirror 46 is in a direction opposite to a direction before being reflected. The circularly polarized light reflected by the half mirror 46 and having a sense of rotation in the opposite direction is incident into the laminate 10 again.

Since the circularly polarized light incident on the laminate 10 again is in a direction opposite to the sense of rotation of the circularly polarized light reflected by the laminate 10, the circularly polarized light is converted into linearly polarized light in a direction of transmitting through the first optically anisotropic film 12 in a case where the circularly polarized light receives the polarization conversion by the second optically anisotropic film 14. Therefore, the light reflected by the half mirror 46 is transmitted through the laminate 10, and is visually recognized by the user.

In the virtual reality display device 40, the optical characteristics obtained by the relationship of the expression (1) in the laminate (laminate 10) according to the embodiment of the present invention are similarly satisfied at each position of the specific position group in the region X, so that the generation of light passing through the first optically anisotropic film 12 as shown by a broken line arrow in FIG. 4 is suppressed, and as a result, the occurrence of the ghost is suppressed.

The image display panel 42 is, for example, a known image display panel (display panel) such as an organic electroluminescence display panel.

In the example shown in FIG. 4, the image display panel 42 emits an image of unpolarized light (image light). The image of unpolarized light emitted from the image display panel 42 passes through the circular polarization plate 44, and is converted into circularly polarized light.

The image display panel 42 may emit linearly polarized light, and in this case, a λ/4 plate may be used instead of the circular polarization plate 44.

### EXAMPLES

Hereinafter, the present invention will be described in more detail with reference to Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

### Production of Laminate of Example 1

A laminate S1 (circular polarization plate) of Example 1 was obtained by the following procedure.

### [First Optically Anisotropic Film]

A first optically anisotropic film (reflective type linear polarizer R1) was obtained according to a method described in U.S. Pat. No. 5,882,774A. The reflective type linear polarizer R1 can be also obtained from 3M as a product name APF as described above.

The first anisotropic orientation and the first average orientation at each specific position (points A to I, see FIG. 2) in the region X having a square shape of 50 cm×50 cm of the reflective type linear polarizer R1 having a size of 52 cm×52 cm were evaluated using an AxoScan (polarimeter) device manufactured by Axometrics, Inc. The results are shown in a table below.

### [Second Optically Anisotropic Film]

A cellulose acylate film was produced by the following procedure, a photoalignment layer was formed on the produced cellulose acylate film, a liquid crystal composition was applied onto the formed photoalignment layer, and an alignment treatment and a curing treatment were carried out to form a second optically anisotropic film.

### (Production of Cellulose Acylate Film T1)

### —Preparation of Core Layer Cellulose Acylate Dope—

The following composition was put into a mixing tank and stirred to dissolve each component, thereby preparing a cellulose acetate solution used as a core layer cellulose acylate dope.

### Core Layer Cellulose Acylate Dope

| | |
|---|---|
| Cellulose acetate having acetyl | 100 parts by mass |
| substitution degree of 2.88 | |
| Polyester compound B described | 12 parts by mass |
| in Examples of JP2015-227955A | |
| Compound G shown below | 2 parts by mass |
| Methylene chloride | 430 parts by mass |
| (first solvent) | |
| Methanol (second solvent) | 64 parts by mass |

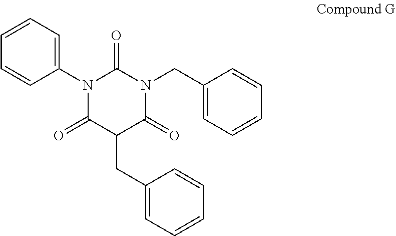 [SMILES: O=C1C(Cc2ccccc2)C(=O)N(c2ccccc2)C(=O)N1Cc1ccccc1]

### —Preparation of Outer Layer Cellulose Acylate Dope—

10 parts by mass of the following matting agent solution was added to 90 parts by mass of the above-described core layer cellulose acylate dope to prepare a cellulose acetate solution used as an outer layer cellulose acylate dope.

### Matting Agent Solution

| | |
|---|---|
| Silica particles having an average | 2 parts by mass |
| particle diameter of 20 nm | |
| (AEROSIL R972, manufactured | |
| by Nippon Aerosil Co., Ltd.) | |
| Methylene chloride (first solvent) | 76 parts by mass |
| Methanol (second solvent) | 11 parts by mass |
| Core layer cellulose acylate dope | 1 part by mass |
| described above | |

### —Casting of Cellulose Acylate Film T1—

The above-described core layer cellulose acylate dope and the above-described outer layer cellulose acylate dope were filtered through a filter paper having an average hole diameter of 34 μm and a sintered metal filter having an average hole diameter of 10 μm. After the filtration, the core layer cellulose acylate dope and the outer layer cellulose acylate dopes on both sides thereof were cast simultaneously on a drum at 20° C. from a casting port in three layers (band casting machine).

After the casting, the film was peeled off from the drum in a state in which the solvent content was approximately 20% by mass, both ends of the film in the width direction were fixed by tenter clips, and the film was dried while being stretched at a stretching ratio of 1.1 times in the lateral direction. Thereafter, the film was transported between rolls of a heat treatment device to be further dried, thereby producing a cellulose acylate film T1 having a thickness of 40 μm. The core layer in the cellulose acylate film T1 had a thickness of 36 μm, and the outer layers disposed on both sides of the core layer each had a thickness of 2 μm. In addition, an in-plane retardation of the obtained cellulose acylate film T1 was 0 nm.

### (Production of Photoalignment Layer 1)

A composition PM-1 for forming a photoalignment layer was prepared with reference to the description of Example 3 of JP2012-155308A, and the composition PM-1 was applied onto the above-described cellulose acylate film T1 with a wire bar. The composition PM-1 was dried with hot air at 60° C. for 60 seconds to form a coating layer P1 having a thickness of 300 nm.

The produced coating layer P1 was irradiated with ultraviolet rays using an ultra-high pressure mercury lamp in the air. At this time, a wire grid polarizer (manufactured by Moxtek, Inc., ProFlux PPL02) was disposed between the lamp and the coating layer P1 to be parallel to the coating layer P1, and the coating layer P1 was irradiated with ultraviolet rays to perform a photoalignment treatment, thereby forming a photoalignment layer 1. The above-described photoalignment treatment was carried out on the coating layer P1 in a region overlapping with the region X of the reflective type linear polarizer R1 in a case of being bonded in a subsequent step. Specifically, the photoalignment treatment was carried out successively for each 20 cm×20 cm region in a state in which an orientation of a transmission axis of the wire grid polarizer was adjusted such that the polarization direction of the ultraviolet rays to be irradiated at each point of the corresponding region on the coating layer P1 side was at an orientation of −45° (45° counterclockwise with respect to the first anisotropic orientation) with respect to the first anisotropic orientation at each point of the region X of the reflective type linear polarizer R1. An illuminance of the ultraviolet rays used for the exposure was set to 10 mJ/cm² in a UV-A region (ultraviolet A rays, integrated wavelength of 320 to 380 nm). In a case where the optically anisotropic layer Q1 described later was formed using the photoalignment layer 1 obtained by the above-described procedure, the anisotropic orientation of the optically anisotropic layer Q1 was at an orientation of +90° (45° clockwise with respect to the first anisotropic orientation) with respect to the polarization direction of the ultraviolet rays irradiated during the alignment treatment for the photoalignment layer 1.

### (Formation of Optically Anisotropic Layer Q1)

### —Preparation of Coating Liquid A1 for Forming Positive A-Plate—

A coating liquid A1 for forming a positive A-plate, having the following formulation, was prepared.

### Composition of Coating Liquid A1 for Forming Positive A-Plate

| | |
|---|---|
| Polymerizable liquid crystal | 16.00 parts by mass |
| compound X-1 shown below | |
| Liquid crystal compound L-1 | 42.00 parts by mass |
| shown below | |
| Liquid crystal compound L-2 | 42.00 parts by mass |
| shown below | |
| Polymerization initiator S-1 | 0.50 parts by mass |
| shown below | |
| Acid anhydride K-1 shown | 4.00 parts by mass |
| below | |
| Polymerizable compound B-1 | 2.00 parts by mass |
| shown below | |
| Leveling agent (compound T-1 | 0.20 parts by mass |
| shown below) | |
| Methyl ethyl ketone (solvent) | 230.00 parts by mass |
| Cyclopentanone (solvent) | 70.00 parts by mass |

### Polymerizable Liquid Crystal Compound X-1, Liquid Crystal Compound L-1, Liquid Crystal Compound L-2, and Compound T-1

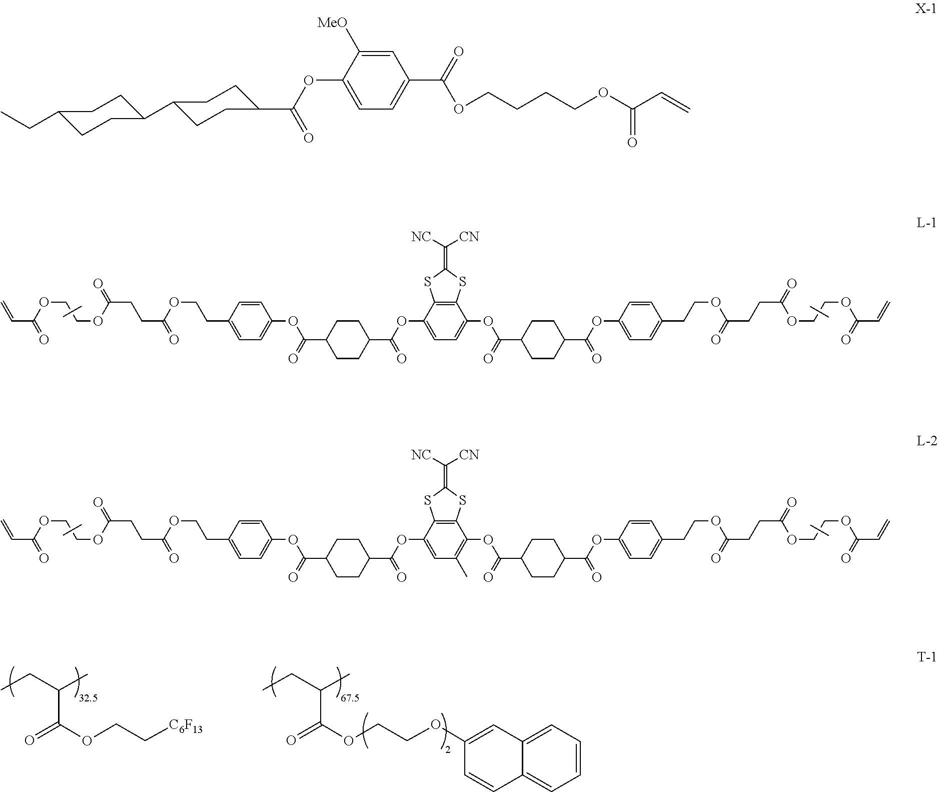

### Polymerization Initiator S-1

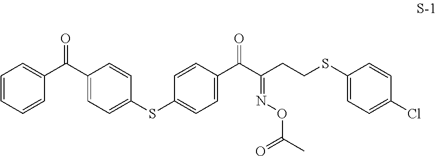 [SMILES: CC(=O)O/N=C(\CCSc1ccc(Cl)cc1)C(=O)c1ccc(Sc2ccc(C(=O)c3ccccc3)cc2)cc1]

### Acid Anhydride K-1

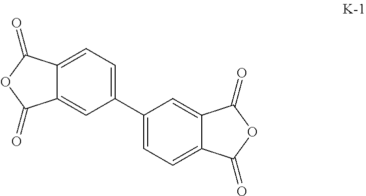 [SMILES: O=C1OC(=O)c2cc(-c3ccc4c(c3)C(=O)OC4=O)ccc21]

### Polymerizable Compound B-1

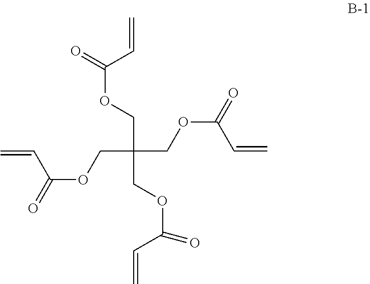 [SMILES: C=CC(=O)OCC(COC(=O)C=C)(COC(=O)C=C)COC(=O)C=C]

Next, the coating liquid A1 for forming a positive A-plate was applied onto the photoalignment layer 1 subjected to the photoalignment treatment with a bar coater to form a coating layer. The coating layer was heated and aged for 20 seconds such that the film surface temperature was 100° C., and cooled to 90° C. to carry out an alignment treatment. After the alignment treatment, the coating layer was irradiated with ultraviolet rays of 300 mJ/cm² using an air-cooled metal halide lamp (manufactured by Eye Graphics Co., Ltd.) in the air to fix the alignment state, thereby forming an optically anisotropic layer Q1 (second optically anisotropic film). After the optically anisotropic layer Q1 was formed, the cellulose acylate film T1 on which the optically anisotropic layer Q1 was laminated was cut to a size of 52 cm×52 cm by removing unnecessary portions, leaving a region subjected to the polarized exposure corresponding to the region X by the photoalignment treatment.

The optically anisotropic layer Q1 formed on one surface side of the cellulose acylate film T1 had a film thickness of 2.4 μm.

For the optically anisotropic layer Q1, light incidence angle dependence of Re (in-plane retardation) and a tilt angle of an optical axis were measured using an automatic birefringence meter (KOBRA-21ADH, manufactured by Oji Scientific Instruments Co., Ltd.). As a result of the measurement, Re was 145 nm and Rth was 73 nm at a wavelength of 550 nm. In addition, Re(450)/Re(550) was 0.81, and Re(650)/Re(550) was 1.01. The tilt angle of the optical axis was 0°, and the liquid crystal compound was homogeneously aligned (horizontally aligned).

The second anisotropic orientation and the second average orientation at each position (positions A to I, see FIG. 2) of the specific position group in the region X were evaluated using an AxoScan (polarimeter) device manufactured by Axometrics, Inc. An orientation of a slow axis (second anisotropic orientation) at each measurement point in the region X is shown in the table below.

### [Adhesive-Attached Film 1]

A pressure sensitive adhesive N1 was prepared with reference to the description of Example 1 of JP2017-134414A, thereby obtaining an adhesive-attached film 1.

### [Production of Laminate (Circular Polarization Plate)]

The cellulose acylate film T1 on which the reflective type linear polarizer R1 and the optically anisotropic layer Q1 were formed was bonded to each other using the above-described pressure sensitive adhesive N1 such that one surface of the reflective type linear polarizer R1 and the optically anisotropic layer Q1 faced each other.

After the bonding, the optically anisotropic layer Q1 and the photoalignment layer 1 were peeled off at an interface therebetween, and the photoalignment layer 1 and the cellulose acylate film T1 were removed from the bonded body.

By the above-described procedure, a reflective circularly polarizing plate C1 including the reflective type linear polarizer R1 (first optically anisotropic film) and the optically anisotropic layer Q1 (second optically anisotropic film) was obtained.

Furthermore, an antireflection layer was formed on the surface of the reflective circularly polarizing plate C1 obtained by the above-described procedure on the optically anisotropic layer Q1 side, thereby obtaining a laminate S1 of Example 1. The antireflection layer was formed by laminating “g-moth” manufactured by GEOMATEC Co., Ltd. as an antireflection film.

An angle between the first anisotropic orientation (reflection axis direction) of the reflective type linear polarizer R1 at each position of the specific position group in the region X of the obtained laminate S1 and the second anisotropic orientation (in-plane slow axis direction) of the optically anisotropic layer Q1 is shown in the table below.

### Production of Laminate of Example 2

A laminate S2 (circular polarization plate) of Example 2 was obtained by the following procedure.

### [First Optically Anisotropic Film]

The same first optically anisotropic film (reflective type linear polarizer R1) as in Example 1 was prepared.

### [Second Optically Anisotropic Film]

A photoalignment layer was formed on the reflective type linear polarizer R1 and a liquid crystal composition was applied onto the photoalignment layer by the following procedure, and the alignment treatment and the curing treatment were carried out to form a second optically anisotropic film.

### (Production of Photoalignment Layer 2 on First Optically Anisotropic Film)

The reflective type linear polarizer R1 was subjected to a corona treatment on one surface thereof, and the above-described composition PM-1 for forming a photoalignment layer was applied onto the treated surface with a wire bar. The composition PM-1 was dried with hot air at 60° C. for 60 seconds to form a coating layer P2 having a thickness of 300 nm.

The produced coating layer P2 was irradiated with ultraviolet rays using an ultra-high pressure mercury lamp in the air. At this time, a wire grid polarizer (manufactured by Moxtek, Inc., ProFlux PPL02) was disposed between the lamp and the coating layer P2 to be parallel to the coating layer P2, and the coating layer P2 was irradiated with ultraviolet rays to perform a photoalignment treatment, thereby forming a photoalignment layer 2. The above-described photoalignment treatment was carried out on the coating layer P2 in a region overlapping with the region X of the reflective type linear polarizer R1. Specifically, the photoalignment treatment was carried out successively for each 20 cm×20 cm region in a state in which an orientation of a transmission axis of the wire grid polarizer was adjusted such that the polarization direction of the ultraviolet rays to be irradiated at each point of the corresponding region on the photoalignment layer P2 side was at an orientation of −45° with respect to the first anisotropic orientation at each point of the region X of the reflective type linear polarizer R1. An illuminance of the ultraviolet rays used for the exposure was set to 10 mJ/cm² in a UV-A region (ultraviolet A rays, integrated wavelength of 320 to 380 nm). In a case where the optically anisotropic layer Q2 described later was formed using the photoalignment layer 2 obtained by the above-described procedure, the anisotropic orientation of the optically anisotropic layer Q2 was at an orientation of +90° with respect to the polarization direction of the ultraviolet rays emitted during the alignment treatment with respect to the photoalignment layer 2.

### (Formation of Optically Anisotropic Layer Q2)

The above-described coating liquid A1 for forming a positive A-plate was applied onto the photoalignment layer 2 subjected to the photoalignment treatment with a bar coater to form a coating layer. The coating layer was heated and aged for 20 seconds such that the film surface temperature was 100° C., and cooled to 90° C. to carry out an alignment treatment. After the alignment treatment, the coating layer was irradiated with ultraviolet rays of 300 mJ/cm² using an air-cooled metal halide lamp (manufactured by Eye Graphics Co., Ltd.) in the air to fix the alignment state, thereby forming an optically anisotropic layer Q2 (second optically anisotropic film). By the above-described procedure, a reflective circularly polarizing plate C2 including the reflective type linear polarizer R1 (first optically anisotropic film), the photoalignment layer 2, and the optically anisotropic layer Q2 (second optically anisotropic film) was obtained. A film thickness of the optically anisotropic layer Q2 was 2.4 μm.

The optically anisotropic layer Q2 was peeled off and transferred onto glass, and optical characteristics were evaluated.

For the optically anisotropic layer Q2, light incidence angle dependence of Re (in-plane retardation) and a tilt angle of an optical axis were measured using an automatic birefringence meter (KOBRA-21ADH, manufactured by Oji Scientific Instruments Co., Ltd.). As a result of the measurement, Re was 145 nm and Rth was 73 nm at a wavelength of 550 nm. In addition, Re(450)/Re(550) was 0.81, and Re(650)/Re(550) was 1.01. The tilt angle of the optical axis was 0°, and the liquid crystal compound was homogeneously aligned (horizontally aligned).

The second anisotropic orientation and the second average orientation at each position (positions A to I, see FIG. 2) of the specific position group in the region X were evaluated using an AxoScan (polarimeter) device manufactured by Axometrics, Inc. An orientation of a slow axis (second anisotropic orientation) at each measurement point in the region X is shown in the table below.

An antireflection layer was formed on the surface of the reflective circularly polarizing plate C2 obtained by the above-described procedure on the optically anisotropic layer Q2 side, thereby obtaining a laminate S2 of Example 2. The antireflection layer was formed by laminating “g-moth” manufactured by GEOMATEC Co., Ltd. as an antireflection film.

An angle between the first anisotropic orientation (reflection axis direction) of the reflective type linear polarizer R1 at each position of the specific position group in the region X of the obtained laminate S2 and the second anisotropic orientation (in-plane slow axis direction) of the optically anisotropic layer Q2 is shown in the table below.

### Production of Laminate of Example 3

A laminate S3 (circular polarization plate) of Example 3 was obtained by the following procedure.

### [First Optically Anisotropic Film]

The same first optically anisotropic film (reflective type linear polarizer R1) as in Example 1 was prepared.

### [Second Optically Anisotropic Film]

A liquid crystal composition was directly applied onto the reflective type linear polarizer R1 by the following procedure, and the alignment treatment and the curing treatment were carried out to form a second optically anisotropic film.

### (Formation of Optically Anisotropic Layer Q3 on First Optically Anisotropic Film)

### —Preparation of Coating Liquid A2 for Forming Twisted Nematic Layer—

A coating liquid A2 for forming a twisted nematic layer, having the following formulation, was prepared.

Formulation of coating liquid A2 for forming twisted nematic layer

| | |
|---|---|
| Polymerizable liquid crystal | 16.00 parts by mass |
| compound X-1 shown above | |
| Liquid crystal compound L-1 | 2.00 parts by mass |
| shown above | |
| Liquid crystal compound L-2 | 42.00 parts by mass |
| shown above | |
| Polymerization initiator S-1 | 0.50 parts by mass |
| shown above | |
| Acid anhydride K-1 shown | 4.00 parts by mass |
| above | |
| Polymerizable compound B-1 | 2.00 parts by mass |
| shown above | |
| Chiral agent CH-1 shown | 0.30 parts by mass |
| below | |
| Leveling agent (compound T-1) | 0.20 parts by mass |
| shown above | |
| Methyl ethyl ketone (solvent) | 230.00 parts by mass |
| Cyclopentanone (solvent) | 70.00 parts by mass |

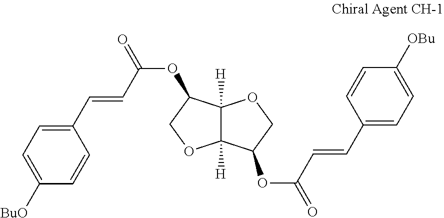

### —Formation of Optically Anisotropic Layer Q3—

The reflective type linear polarizer R1 was subjected to a corona treatment on one surface thereof, and the coating liquid A2 for forming a twisted nematic layer was applied onto the treated surface with a bar coater to form a coating layer. The coating layer was heated and aged for 20 seconds such that the film surface temperature was 100° C., and cooled to 90° C. to carry out an alignment treatment. In the above-described procedure, the liquid crystal compound was aligned in a direction corresponding to the first anisotropic orientation at each point of the reflective type linear polarizer R1.

After the alignment treatment, the coating layer was irradiated with ultraviolet rays of 300 mJ/cm² using an air-cooled metal halide lamp (manufactured by Eye Graphics Co., Ltd.) in the air to fix the alignment state, thereby forming an optically anisotropic layer Q3 (second optically anisotropic film). By the above-described procedure, a reflective circularly polarizing plate C3 including the reflective type linear polarizer R1 (first optically anisotropic film) and the optically anisotropic layer Q3 (second optically anisotropic film) was obtained. A film thickness of the optically anisotropic layer Q3 was 3.2 μm.

The optically anisotropic layer Q3 was peeled off and transferred onto glass, and was evaluated using AxoScan (polarimeter) device manufactured by Axometrics, Inc. The liquid crystal compound was twisted nematic aligned, and a twist angle thereof was 64°. That is, in the optically anisotropic layer Q3, an alignment direction of the liquid crystal compound on one surface was rotated by 64° with a direction toward the other surface as a helical axis.

The twisted nematic film having a twist angle of 180° or less exhibited behavior as a retardation film. As an anisotropic orientation of the retardation film of the optically anisotropic layer Q3, the second anisotropic orientation and the second average orientation at each position (positions A to I, see FIG. 2) of the specific position group in the region X were evaluated using the same AxoScan (polarimeter) device manufactured by Axometrics, Inc. An orientation of a slow axis (second anisotropic orientation) at each measurement point in the region X is shown in the table below.

An antireflection layer was formed on the surface of the reflective circularly polarizing plate C3 obtained by the above-described procedure on the optically anisotropic layer Q3 side, thereby obtaining a laminate S3 of Example 3. The antireflection layer was formed by laminating “g-moth” manufactured by GEOMATEC Co., Ltd. as an antireflection film.

An angle between the first anisotropic orientation (reflection axis direction) of the reflective type linear polarizer R1 at each position of the specific position group in the region X of the obtained laminate S3 and the second anisotropic orientation (in-plane slow axis direction) of the optically anisotropic layer Q3 is shown in the table below.

### Production of Laminate of Example 4

A laminate S4 (circular polarization plate) of Example 4 was obtained by the following procedure.

### [First Optically Anisotropic Film]

The same first optically anisotropic film (reflective type linear polarizer R1) as in Example 1 was prepared.

### [Second Optically Anisotropic Film]

A photoalignment layer was formed on the reflective type linear polarizer R1 and a liquid crystal composition was applied onto the photoalignment layer by the following procedure, and the alignment treatment and the curing treatment were carried out to form a second optically anisotropic film.

### (Production of Photoalignment Layer 4 on First Optically Anisotropic Film)

The reflective type linear polarizer R1 was subjected to a corona treatment on one surface thereof, and the above-described composition PM-1 for forming a photoalignment layer was applied onto the treated surface with a wire bar. The composition PM-1 was dried with hot air at 60° C. for 60 seconds to form a coating layer P4 having a thickness of 300 nm.

Next, the obtained coating layer P4 was irradiated with ultraviolet rays (illuminance: 4.5 mW, irradiation amount: 50 mJ/cm²) using an ultraviolet exposure device in a state of being exposed from the reflective type linear polarizer side, thereby producing a photoalignment layer 4. The coating layer P4 was irradiated with ultraviolet rays transmitted through the reflective type linear polarizer R1. In the above-described procedure, ultraviolet light having a polarization direction determined in accordance with the first anisotropic orientation at each point of the reflective type linear polarizer R1 was transmitted.

### (Formation of Optically Anisotropic Layer Q4)

The above-described coating liquid A2 for forming a twisted nematic layer was applied onto the photoalignment layer 4 subjected to the photoalignment treatment with a bar coater to form a coating layer. The coating layer was heated and aged for 20 seconds such that the film surface temperature was 100° C., and cooled to 90° C. to carry out an alignment treatment. After the alignment treatment, the coating layer was irradiated with ultraviolet rays of 300 mJ/cm² using an air-cooled metal halide lamp (manufactured by Eye Graphics Co., Ltd.) in the air to fix the alignment state, thereby forming an optically anisotropic layer Q4 (second optically anisotropic film). By the above-described procedure, a reflective circularly polarizing plate C4 including the reflective type linear polarizer R1 (first optically anisotropic film), the photoalignment layer 4, and the optically anisotropic layer Q4 (second optically anisotropic film) was obtained. A film thickness of the optically anisotropic layer Q4 was 3.2 μm.

The optically anisotropic layer Q4 was peeled off and transferred onto glass, and was evaluated using AxoScan (polarimeter) device manufactured by Axometrics, Inc. The liquid crystal compound was twisted nematic aligned, and a twist angle thereof was 64°.

The twisted nematic film having a twist angle of 180° or less exhibited behavior as a retardation film. As an anisotropic orientation of the retardation film of the optically anisotropic layer Q4, the second anisotropic orientation and the second average orientation at each position (positions A to I, see FIG. 2) of the specific position group in the region X were evaluated using the same AxoScan (polarimeter) device manufactured by Axometrics, Inc. An orientation of a slow axis (second anisotropic orientation) at each measurement point in the region X is shown in the table below.

An antireflection layer was formed on the surface of the reflective circularly polarizing plate C4 obtained by the above-described procedure on the optically anisotropic layer Q4 side, thereby obtaining a laminate S4 of Example 4. The antireflection layer was formed by laminating “g-moth” manufactured by GEOMATEC Co., Ltd. as an antireflection film.

An angle between the first anisotropic orientation (reflection axis direction) of the reflective type linear polarizer R1 at each position of the specific position group in the region X of the obtained laminate S4 and the second anisotropic orientation (in-plane slow axis direction) of the optically anisotropic layer Q4 is shown in the table below.

### Production of Laminate of Comparative Example 1

An optically anisotropic layer QC1 was formed by the same procedure as in the production procedure of the laminate of Example 1, except that the entire surface of the coating layer P1 was uniformly irradiated with linearly polarized light such that the angle α between the first average orientation and the second average orientation was 45° after the bonding, and the reflective type linear polarizer R1 and the optically anisotropic layer QC1 were bonded to each other, thereby obtaining a laminate SC1 of Comparative Example 1.

### Production of Virtual Reality Display Device

A virtual reality display device “VIVE FLOW” manufactured by HTC Corporation was disassembled, and an optical lens was taken out. The “VIVE FLOW” is a virtual reality display device in which a pancake lens is adopted, and a liquid crystal display device which emits circularly polarized light by a polarizing plate bonded to a surface is used as an image display device.

In addition, the optical lens taken out included two types of lenses, one of which was a biconvex lens having a half-mirror coating on one surface and the other of which was a plano-convex lens having an optical laminate bonded to a plane.

The optical laminate on the above-described plano-convex lens plane side was removed, and the laminate S1 cut out to match the size of the lens was bonded. In this case, the reflective type linear polarizer R1 side of the laminate S1 was bonded to be positioned on the plane side of the plano-convex lens. The plano-convex lens to which the laminate S1 was bonded was assembled into the original virtual reality display device to produce a virtual reality display device V1 using the laminate S1.

In the same manner, virtual reality display devices V2 to V4 and VC1 using the laminates S2 to S4 and SC1 were also produced.

### <Evaluation>

For each virtual reality display device obtained by the above-described procedure, a black and white checkerboard pattern was displayed on the image display device, and occurrence of a ghost was evaluated based on the following evaluation standard. The ghost occurred in a case where there was light leakage from the above-described laminate, and in the black and white checkerboard pattern, the occurrence of the ghost corresponds to the fact that a boundary portion between the white and the black of the checkerboard pattern was visually recognized as double or multiple.
A: no double image was visible, or a double image was slightly visible but not noticeable.
B: easily recognizable double image was observed, causing difficulty in viewing.

The above-described evaluation was performed using a laminate cut out at a portion corresponding to each position of the specific position group in the region X.

### <Result>

The first anisotropic orientation and the second anisotropic orientation at each position of the specific position group in the region X of the laminate of each of Examples and Comparative Example, and the first average orientation and the second average orientation are shown in Table 1. In addition, Table 1 shows the results of the evaluation performed by cutting out the member from the portion of the laminate corresponding to each position of the specific position group.

In Table 1, the column of “γ” indicates an angle between the first anisotropic orientation and the first average orientation at each position of the specific position group.

TABLE 1

| | | | Point A | Point B | Point C | Point D | Point E | Point F | Point G | Point H | Point I |
|---|---|---|---|---|---|---|---|---|---|---|---|
| Example 1 | First optically | First | 88.0 | 89.6 | 91.9 | 88.0 | 89.6 | 91.9 | 88.0 | 89.6 | 91.9 |
| | anisotropic film | anisotropic | | | | | | | | | |
| | reflective type | orientation | | | | | | | | | |
| | linear polarizer R1) | First average | 89.8 | | | | | | | | |
| | [°] | orientation | | | | | | | | | |
| | | γ | 1.8 | 0.2 | 2.1 | 1.8 | 0.2 | 2.1 | 1.8 | 0.2 | 2.1 |
| | Second optically | Second | 133.0 | 134.7 | 136.9 | 132.9 | 134.7 | 136.9 | 132.9 | 134.6 | 137.0 |
| | anisotropic film | anisotropic | | | | | | | | | |
| | (optically | orientation | | | | | | | | | |
| | anisotropic | Second average | 134.8 | | | | | | | | |
| | layer Q1) | orientation | | | | | | | | | |
| | [°] | α | 45.0 | | | | | | | | |
| | | β | 45.0 | 45.1 | 45.0 | 44.9 | 45.1 | 45.0 | 44.9 | 45.0 | 45.1 |
| | | Absolute value | 0.0 | 0.1 | 0.0 | 0.1 | 0.1 | 0.0 | 0.1 | 0.0 | 0.1 |
| | | of β-α | | | | | | | | | |
| | Evaluation of ghost | | A | A | A | A | A | A | A | A | A |
| Example 2 | First optically | First | 88.0 | 89.6 | 91.9 | 88.0 | 89.6 | 91.9 | 88.0 | 89.6 | 91.9 |
| | anisotropic film | anisotropic | | | | | | | | | |
| | (reflective type | orientation | | | | | | | | | |
| | linear polarizer R1) | First average | 89.8 | | | | | | | | |
| | [°] | orientation | | | | | | | | | |
| | | γ | 1.8 | 0.2 | 2.1 | 1.8 | 0.2 | 2.1 | 1.8 | 0.2 | 2.1 |
| | Second optically | Second | 133.0 | 134.7 | 136.9 | 132.9 | 134.7 | 136.9 | 132.9 | 134.6 | 137.0 |
| | anisotropic film | anisotropic | | | | | | | | | |
| | (optically | orientation | | | | | | | | | |
| | anisotropic | Second average | 134.8 | | | | | | | | |
| | layer Q2) | orientation | | | | | | | | | |
| | [°] | α | 45.0 | | | | | | | | |
| | | β | 45.0 | 45.1 | 45.0 | 44.9 | 45.1 | 45.0 | 44.9 | 45.0 | 45.1 |
| | | Absolute value | 0.0 | 0.1 | 0.0 | 0.1 | 0.1 | 0.0 | 0.1 | 0.0 | 0.1 |
| | | of β-α | | | | | | | | | |
| | Evaluation of ghost | | | A | A | A | A | A | A | A | A |
| Example 3 | First optically | First | 88.0 | 89.6 | 91.9 | 88.0 | 89.6 | 91.9 | 88.0 | 89.6 | 91.9 |
| | anisotropic film | anisotropic | | | | | | | | | |
| | (reflective type | orientation | | | | | | | | | |
| | linear polarizer R1) | First average | 89.8 | | | | | | | | |
| | [°] | orientation | | | | | | | | | |
| | | γ | 1.8 | 0.2 | 2.1 | 1.8 | 0.2 | 2.1 | 1.8 | 0.2 | 2.1 |
| | Second optically | Second | 120.0 | 121.6 | 123.9 | 120.0 | 121.6 | 123.9 | 120.0 | 121.6 | 123.9 |
| | anisotropic film | anisotropic | | | | | | | | | |
| | (optically | orientation | | | | | | | | | |
| | anisotropic | Second average | 121.8 | | | | | | | | |
| | layer Q3) | orientation | | | | | | | | | |
| | [°] | α | 32.0 | | | | | | | | |
| | | β | 32.0 | 32.0 | 32.0 | 32.0 | 32.0 | 32.0 | 32.0 | 32.0 | 32.0 |
| | | Absolute value | 0.0 | 0.0 | 0.0 | 0.0 | 0.0 | 0.0 | 0.0 | 0.0 | 0.0 |
| | | of β-α | | | | | | | | | |
| | Evaluation of ghost | | | A | A | A | A | A | A | A | A |
| Example 4 | First optically | First | 88.0 | 89.6 | 91.9 | 88.0 | 89.6 | 91.9 | 88.0 | 89.6 | 91.9 |
| | anisotropic film | anisotropic | | | | | | | | | |
| | (reflective type | orientation | | | | | | | | | |
| | linear polarizer R1) | First average | 89.8 | | | | | | | | |
| | [°] | orientation | | | | | | | | | |
| | | γ | 1.8 | 0.2 | 2.1 | 1.8 | 0.2 | 2.1 | 1.8 | 0.2 | 2.1 |
| | Second optically | Second | 120.0 | 121.6 | 123.9 | 120.0 | 121.6 | 123.9 | 120.0 | 121.6 | 123.9 |
| | anisotropic film | anisotropic | | | | | | | | | |
| | (optically | orientation | | | | | | | | | |
| | anisotropic | Second average | 121.8 | | | | | | | | |
| | layer Q4) | orientation | | | | | | | | | |
| | [°] | α | 32.0 | | | | | | | | |
| | | β | 32.0 | 32.0 | 32.0 | 32.0 | 32.0 | 32.0 | 32.0 | 32.0 | 32.0 |
| | | Absolute value | 0.0 | 0.0 | 0.0 | 0.0 | 0.0 | 0.0 | 0.0 | 0.0 | 0.0 |
| | | of β-α | | | | | | | | | |
| | Evaluation of ghost | | | A | A | A | A | A | A | A | A |
| Comparative | First optically | First | 88.0 | 89.6 | 91.9 | 88.0 | 89.6 | 91.9 | 88.0 | 89.6 | 91.9 |
| Example 1 | anisotropic film | anisotropic | | | | | | | | | |
| | (reflective type | orientation | | | | | | | | | |
| | linear polarizer R1) | First average | 89.8 | | | | | | | | |
| | [°] | orientation | | | | | | | | | |
| | | γ | 1.8 | 0.2 | 2.1 | 1.8 | 0.2 | 2.1 | 1.8 | 0.2 | 2.1 |
| | Second optically | Slow axis | 134.8 | 134.8 | 134.8 | 134.8 | 134.8 | 134.8 | 134.8 | 134.8 | 134.8 |
| | anisotropic film | direction | | | | | | | | | |
| | (optically | Second average | 134.8 | | | | | | | | |
| | anisotropic layer | orientation | | | | | | | | | |
| | QC1) | α | 45.0 | | | | | | | | |
| | [°] | β | 46.8 | 45.2 | 42.9 | 46.8 | 45.2 | 42.9 | 46.8 | 45.2 | 42.9 |
| | | Absolute value | 1.8 | 0.2 | 2.1 | 1.8 | 0.2 | 2.1 | 1.8 | 0.2 | 2.1 |
| | | of β-α | | | | | | | | | |

| | | | | | | | | |
|---|---|---|---|---|---|---|---|---|
| Evaluation of ghost | A | B | B | A | B | B | A | B |

From the results shown in Table 1, it was found that, even in a case where the first optically anisotropic film in which the maximum value of the angle between the first average orientation and the first anisotropic orientation in the region X (see column of “γ” in Table 1) was in a range of 0.5° to 5.0° was used, as the laminate in which the second anisotropic orientation was adjusted such that the relationship of the expression (2) was satisfied at each position of the specific position group for the second optically anisotropic film (see column of “Absolute value of β−α” in Table 1) was used, a member suppressing the occurrence of the ghost in a case of being adopted to a head mounted display could be cut out more.

On the other hand, in a case where the laminate was obtained using the second optically anisotropic film which did not satisfy the relationship of the expression (2) (see column of “Absolute value of β−α” in Table 1), a member in which the ghost occurred was cut out more.

### EXPLANATION OF REFERENCES

10: laminate
12: first optically anisotropic film
14: second optically anisotropic film
40: virtual reality display device
42: image display panel
44: circular polarization plate
46: half mirror

What is claimed is:

1. A laminate comprising:
a first optically anisotropic film; and
a second optically anisotropic film,
wherein, in a case where, in a 50 cm×50 cm square region X within a plane of the laminate, an average orientation of directions in which an optical anisotropy of the first optically anisotropic film is largest at positions of a specific position group consisting of positions corresponding to vertices of the square, midpoint positions of sides of the square, and a centroid position of the square is defined as a first average orientation, and an average orientation of directions in which an optical anisotropy of the second optically anisotropic film is largest at each position of the specific position group in the region X is defined as a second average orientation,
a maximum value among angles between the direction in which the optical anisotropy of the first optically anisotropic film is largest at each position of the specific position group and the first average orientation is in a range of 0.5° to 5.0°,
an angle α between the first average orientation and the second average orientation satisfies a relationship of an expression (1), and
in a case where an angle between a direction in which the optical anisotropy of the first optically anisotropic film is largest at any position in the region X and a direction in which the optical anisotropy of the second optically anisotropic film is largest at the position is defined as an angle β, all of the angles β at each position of the specific position group satisfy a relationship of an expression (2),
$$10 ° < α < 80 ° , \qquad the expression ( 1 )$$
$$0 ° \leq \vert β - α \vert 1 ° . \qquad the expression ( 2 )$$

2. The laminate according to claim 1,
wherein the laminate has an elongated shape.

3. The laminate according to claim 2,
wherein the first average orientation is 80° to 100° with respect to a longitudinal direction of the elongated shape.

4. The laminate according to claim 1,
wherein the first optically anisotropic film is a stretching film.

5. The laminate according to claim 2,
wherein the first optically anisotropic film is a stretching film.

6. The laminate according to claim 3,
wherein the first optically anisotropic film is a stretching film.

7. The laminate according to claim 1,
wherein the first optically anisotropic film is a linear polarizer.

8. The laminate according to claim 2,
wherein the first optically anisotropic film is a linear polarizer.

9. The laminate according to claim 3,
wherein the first optically anisotropic film is a linear polarizer.

10. The laminate according to claim 1,
wherein the first optically anisotropic film is a reflective type linear polarizer.

11. The laminate according to claim 1,
wherein an in-plane retardation of the second optically anisotropic film at a wavelength of 550 nm is 110 to 170 nm.

12. The laminate according to claim 1
wherein the angle α is 43° to 47°.

13. The laminate according to claim 1,
wherein the second optically anisotropic film contains an aligned liquid crystal compound.

14. The laminate according to claim 1,
wherein the second optically anisotropic film contains a twisted nematic aligned liquid crystal compound.

15. The laminate according to claim 1,
wherein the first optically anisotropic film is adjacent to the second optically anisotropic film.

16. The laminate according to claim 1, further comprising:
a photoalignment layer between the first optically anisotropic film and the second optically anisotropic film.

17. A display device comprising:
the laminate according to claim 1.

18. The display device according to claim 17,
wherein the display device is a virtual reality display device.

19. A wound roll comprising:
the laminate according to claim 1,
wherein the laminate having an elongated shape is wound.
